(19) United States
(12) Patent Application Publication
(10) Pub. No.: US 2026/0310586 A1
(43) Pub. Date: Oct. 8, 2026

(54) EXECUTING MOBILITY TESTS THROUGH TAGS CALLED VIA APPLICATION PROGRAMMING INTERFACES

(71) Applicant: AT&T Intellectual Property I, L.P., Atlanta, GA (US)

(72) Inventors: Sean Simon, Lynnwood, WA (US); Ananya Gurrala, Bothell, WA (US); Aman Deep Gill, Mill Creek, WA (US)

(21) Appl. No.: 19/098,858

(22) Filed: Apr. 2, 2025

(51) Int. Cl. G06F 11/3668

(52) U.S. Cl. CPC G06F 11/3684; G06F 11/3688

(57) ABSTRACT

A method performed by a processing system including at least one processor includes receiving an identification of a first tag indicating a testing criterion for a test to be executed against a mobility network, identifying, from among a plurality of test cases, a subset of the plurality of test cases to which the first tag has been applied, generating a test suite including the subset of the plurality of test cases, executing the test suite against an element of the mobility network, and exposing a result of the executing the test suite via an application programming interface.

The present disclosure relates generally to mobility networks, and relates more particularly to devices, non-transitory computer-readable media, and methods for executing mobility tests through tags called via application programming interfaces.

### BACKGROUND

Mobility networks require periodic functional testing to perform validations of mobility signaling, traffic volumes, billing, and other network functions. Automated test solutions provide catalogs of test cases which can be scheduled, manually executed, or called via an application programming interface (API) to be executed in the mobility network. Test suites (i.e., collections of related test cases designed to test specific features or functionalities of the mobility network, grouped for efficient execution and reporting) are then used before, during, or after maintenance activities, updates, or releases to ensure that a defined pass criterion has been met. Test suites can scale to the hundreds and are dynamic as mobility systems grow or as new functionalities or services are delivered.

### SUMMARY

The present disclosure broadly discloses methods, computer-readable media, and systems for executing mobility tests through tags called via application programming interfaces. In one example, a method performed by a processing system including at least one processor includes receiving an identification of a first tag indicating a testing criterion for a test to be executed against a mobility network, identifying, from among a plurality of test cases, a subset of the plurality of test cases to which the first tag has been applied, generating a test suite including the subset of the plurality of test cases, executing the test suite against an element of the mobility network, and exposing a result of the executing the test suite via an application programming interface.

In another example, a non-transitory computer-readable medium may store instructions which, when executed by a processing system including at least one processor, cause the processing system to perform operations. The operations may include receiving an identification of a first tag indicating a testing criterion for a test to be executed against a mobility network, identifying, from among a plurality of test cases, a subset of the plurality of test cases to which the first tag has been applied, generating a test suite including the subset of the plurality of test cases, executing the test suite against an element of the mobility network, and exposing a result of the executing the test suite via an application programming interface.

In another example, a device may include a processing system including at least one processor and a non-transitory computer-readable medium storing instructions which, when executed by the processing system, cause the processing system to perform operations. The operations may include receiving an identification of a first tag indicating a testing criterion for a test to be executed against a mobility network, identifying, from among a plurality of test cases, a subset of the plurality of test cases to which the first tag has been applied, generating a test suite including the subset of the plurality of test cases, executing the test suite against an element of the mobility network, and exposing a result of the executing the test suite via an application programming interface.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for executing mobility tests through tags called via application programming interfaces may operate;

FIG. 2 illustrates a flowchart of an example method for executing mobility tests through tags called via application programming interfaces, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for executing mobility tests through tags called via application programming interfaces. As discussed above, mobility networks require periodic functional testing to perform validations of mobility signaling, traffic volumes, billing, and other network functions. Automated test solutions provide catalogs of test cases which can be scheduled, manually executed, or called via an API to be executed in the mobility network. Test suites (i.e., collections of related test cases designed to test specific features or functionalities of the mobility network, grouped for efficient execution and reporting) are then used before, during, or after maintenance activities, updates, or releases to ensure that a defined pass criterion has been met. Test suites can scale to the hundreds and are dynamic as mobility systems grow or as new functionalities or services are delivered.

Testing may vary based on scope, system under test, and test purpose. Some testing methods may require specific test suites to be generated for any possible scenario, and the test case scripts to be executed via APIs to be known and configured in advance. Any change in the scope or change in script name requires coordinated configurations between systems, which is complex, time consuming, and prone to errors.

Examples of the present disclosure apply tags (e.g., metadata tags) to mobility test cases, where the tags can be used in a testing framework's API interface for simpler, more flexible text execution. The tags applied to individual test cases may be curated by human testers or administrators and may include specific Third Generation Partnership Project (3GPP) scenarios and test categories, among other characteristics. The tags also allow users of the testing framework to search for test cases that match one or more desired criteria (e.g., by searching for test cases having tags that match the desired criteria), without requiring knowledge of test case names or how test cases are defined by the automated testing framework.

For instance, tags can be searched via a graphical user interface (GUI), via a page for an API in the GUI, or via a third-party application using APIs integrated with the testing framework. In some examples, the search results yielded for a tag may automatically initiate execution of test cases included in the search results (i.e., test cases that match the desired one or more criteria), and the test cases may be queued based on resource availability.

Similarly, an external system may call a specific tag, and any test cases to which the specific tag have been applied may be identified as candidates for execution. Thus, adjacent systems would not necessarily need to have knowledge of script-level details or the number of test cases within a given test suite; the adjacent systems would only need to have knowledge of the tag and scenario to effectuate execution of the correct test suite.

Thus, the use of tags allows any given test case to be used within multiple different test suites, scenarios, or use cases, without the need to create use-case-specific test object lists (TOLs). Test cases can also be reused at various stages of a mobility network's lifecycle (including pre-deployment, during deployment, post-deployment, post-configuration, integration, pre-upgrade, post-upgrade, and health checks). Additionally, the use of tags allows the scope of a test suite to be dynamically modified (e.g., to expand or deprecate test cases) without extensive coordination or modification of existing automation pipelines. A subject matter expert (SME) may simply modify the tags applied to a test case to remove the test case from the scope of a test suite. The API calls to execute a given scenario do not need to be modified; only the scope of the test suite changes due to the addition or removal of tags. The disclosed approach also allows specific scenarios to be called using plain language, mobility platforms, or 3GPP standards, without requiring extensive low-level knowledge of the testing framework catalog.

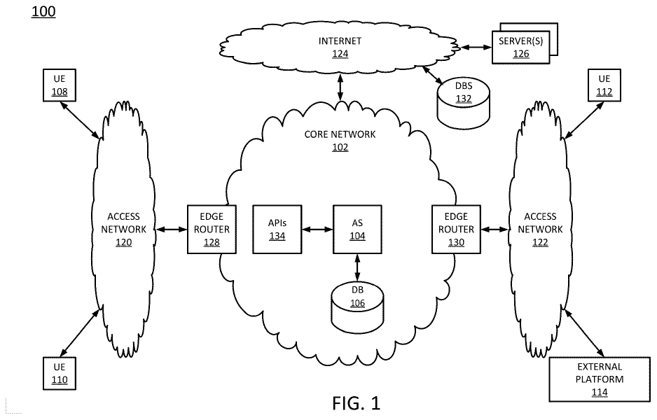

Examples of the present disclosure therefore simplify the process of identifying relevant test cases for execution and maximize the probability of executing the correct test suite. Examples of the present disclosure may also speed the process of testing releases with new features by allowing a regression to be run on available features that have already been automated, ensuring the stability of the latest releases and marking existing functionalities as intact. Examples of the present disclosure require no modifications to automation pipelines that are executed or shared within systems to perform test executions; instead, only the tags within the text automation can be modified. This reduces the resources required to coordinate between systems, and also allows for rapid changes in test scope without extension reconfiguration of dependent systems. These and other aspects of the present disclosure are discussed in greater detail below in connection with the examples of FIGS. 1-3.

To further aid in understanding the present disclosure, FIG. 1 illustrates an example system 100 in which examples of the present disclosure for executing mobility tests through tags called via application programming interfaces may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, at least one database (DB) 106, a plurality of edge routers 128-130, and APIs 134. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

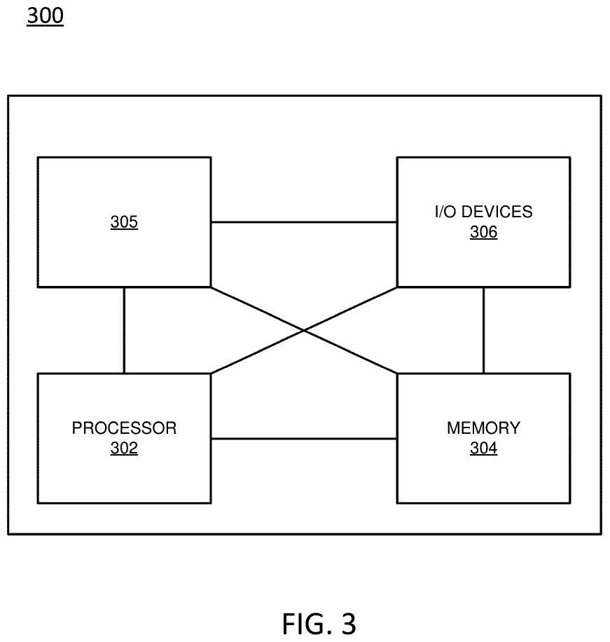

In one example, the access network 120 may be in communication with one or more user endpoint devices 108 and 110. Similarly, the access network 122 may be in communication with one or more user endpoint devices 112 and/or external platforms 114. The access networks 120 and 122 may transmit and receive communications between the user endpoint devices 108, 110, and 112, and external platforms 114, between the user endpoint devices 108, 110, and 112, and external platforms 114, the server(s) 126, the AS 104, other components of the core network 102, devices reachable via the Internet in general, and so forth. In one example, each of the user endpoint devices 108, 110, and 112 may comprise any single device or combination of devices that may comprise a user endpoint device, such as computing system 300 depicted in FIG. 3, and may be configured as described below. For example, the user endpoint devices 108, 110, and 112 may each comprise a mobile device, a cellular smart phone, a gaming console, a set top box, a laptop computer, a tablet computer, a desktop computer, an application server, a bank or cluster of such devices, and the like. In one example, any one of the user endpoint devices 108, 110, and 112 may be operable by a human user to control operations of the AS 104, which may be configured to automate testing for mobility networks, as discussed in greater detail below. For instance, any one of the user endpoint devices 108, 110, and 112 may be operable to access a GUI via which operations of the AS 104 may be controlled.

In one example, the external platforms 114 may comprise automated testing deployment pipelines for executing test suites against a mobility network and/or external (e.g., third party) APIs that are integrated with the AS 104.

In one example, one or more servers 126 and one or more databases 132 may be accessible to user endpoint devices 108, 110, and 112, and external platforms 114 via Internet 124 in general. The server(s) 126 and DBs 132 may be configured to operate in a manner similar to the AS 104 and DBs 106.

In accordance with the present disclosure, the AS 104 may be configured to provide one or more operations or functions in connection with examples of the present disclosure for executing mobility tests through tags called via application programming interfaces, as described herein. The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the AS 104 may be configured to automate testing for mobility networks. In particular, the AS 104 may be configured to search DB 106 for test cases having tags (e.g., metadata tags) that match a tag specified by a user (e.g., via UE 108, 110, or 112) or specified by an external platform or system 114. For instance, a specified tag may correspond to a 3GPP scenario, to a test category, or to some other characteristic of the test cases. The AS 104 may identify, within the DB 106, a subset of test cases that have been tagged with the specified tag and may generate a test suite using the subset of test cases (where generating the test suite may include queueing the subset of test cases in an order to be executed). Similarly, if the AS 104 subsequently determines that the specified tag has been removed from one of the test cases in the subset of test cases, the AS 104 may remove the one of the test cases from the test suite.

The test suite may be executed against the mobility network via the APIs 134. The APIs 134 may also expose the results of the executed test suite (e.g., KPIs measured during execution of the test suite) to the user or external platform or system 114 that requested the testing.

In one example, the DB 106 may comprise a repository for test cases. The test cases may comprise predefined test cases that have been executed against mobility networks in the past. As discussed above, at least some of the test cases stored in the DB 106 may include tags (e.g., metadata tags) that may indicate 3GPP scenarios, test categories, or other characteristics of the test cases. In one example, a test case may include more than one tag. Similarly, the same tag may be applied to more than one different test case.

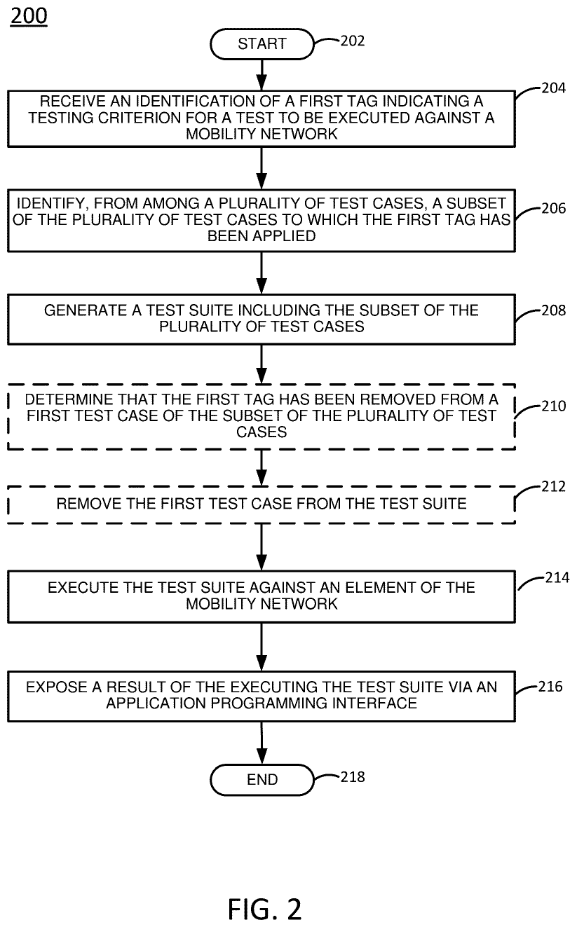

In one example, the DBs 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for executing mobility tests through tags called via application programming interfaces, as described herein. One example method for executing mobility tests through tags called via application programming interfaces is described in greater detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, and 112, and external platforms 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for executing mobility tests through tags called via application programming interfaces, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system in a telecommunications service provider network, such as processing system 302.

The method 200 begins in step 202 and proceeds to step 204. In step 204, the processing system may receive an identification of a first tag indicating a testing criterion (e.g., one or more criteria) for a test to be executed against a mobility network.

In one example, the tag may describe one or more criteria or characteristics of a test which a user wishes to execute against the mobility network. For instance, in one example, the tag may describe a 3GPP scenario, such as a 3GPP scenario for attach, for Voice over LTE (VoLTE), Voice over New Radio (VoNR, also referred to as Voice over 5G), or another 3GPP specific scenario. In another example, the tag may describe a test category, such as integration, regression, development, nodal, chaos, or the like. In another example, the tag may describe another characteristic of the test such as a release number or version of a feature of the mobility network, a zone name of a zone of the mobility network, or the like.

In one example, the first tag may be selected by a user via a GUI, where the GUI may display a list of predefined tags from which the user may choose one or more. In another example, the user may enter the first tag in a freeform field of the GUI. In another example, an external system may automatically call the first tag to trigger execution of a test suite.

The first tag may be one of a plurality of tags indicating one or more testing criteria for the test. That is, more than one tag may be specified in step 202, and the processing system may perform at least some of the following steps for each of the tags that is specified.

In step 206, the processing system may identify, from among a plurality of test cases, a subset of the plurality of test cases to which the first tag has been applied.

In one example, the processing system may have access to a repository that stores a plurality of test cases. The plurality of test cases may include test cases that have been executed against the mobility network in the past. At least some of the plurality of test cases may be tagged with metadata tags. These tags may describe characteristics of a test case to which the tags are applied. For instance, as discussed above, a tag may describe a 3GPP specific scenario, a test category, or another characteristic of a test case.

Upon receiving the first tag, the processing system may search the repository for any test cases in the repository having tags that match the first tag. In one example, a tag applied to a test case may be considered to match the first tag when the tag applied to the test case exactly matches the first tag (e.g., is identical). In another example, a tag applied to a test case may be considered to match the first tag when the tag applied to the test case is a semantic match to the first tag (e.g., not identical, but expresses a common concept or characteristic). In another example, a tag applied to a test case may be considered to match the first tag when the tag applied to the test case is a subset or subcategory of the first tag.

In step 208, the processing system may generate a test suite including the subset of the plurality of test cases.

In one example, generating the test suite may include queuing the subset of the plurality of test cases in an order for execution. The order may be determined at least in part based on resource availability (e.g., if resource availability is limited, the test cases that are considered most important may be scheduled earlier in the test suite than test cases that are considered less important).

As discussed above, more than one tag may be specified in step 204, and the processing system may perform at least some of the steps following step 204 for each of the tags that is specified. For instance, step 206 may be repeated for each tag of the plurality of tags, and at least one further test case identified as a result of repeating step 206 may be included in the test suite in step 208.

In optional step 210 (illustrated in phantom), the processing system may determine that the first tag has been removed from a first test case of the subset of the plurality of test cases.

In one example, tags may be dynamically applied to or removed from a test case at any time. Thus, if the first tag is removed from the first test case, this may indicate that the first test case is no longer suitable for inclusion in the test suite (e.g., is no longer considered to serve the aims of the testing to be executed against the mobility network).

In optional step 212 (illustrated in phantom), the processing system may remove the first test case from the test suite.

As discussed above, if the first tag is removed from the first test case, this may indicate that the first test case is no longer suitable for inclusion in the test suite (e.g., is no longer considered to serve the aims of the testing to be executed against the mobility network, or is no longer considered within the scope of the testing). In one example, removing the first tag from the first test case will automatically result in the first test case being removed from the test suite. Thus, the scope of the test suite may be changed without modifying the APIs used to execute the test suite.

Similarly, if the first tag is newly applied to a second test case to which the first tag was not previously applied (e.g., not applied prior to step 206), this may automatically result in the second test case being added to the test suite. Again, the scope of the test suite may be changed without modifying the APIs used to execute the test suite.

In step 214, the processing system may execute the test suite against an element of the mobility network.

In one example, the element of the mobility network may be a network function (NF). NFs may have different states of configuration which require their own tests (e.g., command-line interface-based, API, mobility, live device, etc.). In one example, the processing system executes the test suite against the element of the mobility network via an API. As an example, an API used to initiate a test may look like:

```
{
  “testCaseObj”: {
    “zoneName”:[
    “zoneName1”
],
  “labels”:[
    “label1”
],
  “category”:[
    “category1”
],
  “3GPPScenario”:[
    “scenario1”
],
  “capturePCAP” : “True”,
  “loglevel” : “Info”,
  “emailNotificationAddressesViaAPI” : attUID@att.com
  }
}
```

In step 216, the processing system may expose a result (e.g., one or more results) of the executing the test suite via an application programming interface. Exposure of the results via the API may allow for review of the results, e.g., by a human administrator or external system. The method 200 may end in step 218.

Thus, examples of the method 200 may utilize a GUI to stitch together individual pieces of automation into a flow that requires only a single instruction from a user. Test suites that can be executed in this manner may include test suites to check infrastructure details, to verify necessary pre-conditions, to validate a network function pod layout, to validate a microservice, to validate networks and interfaces, to validate configurations, to perform network security checks, to validate nodal registrations, to perform security scans, and to access common systems, among others. Thus, examples of the method 200 may support 3, 2, 1, 0 for network functions, including pre-checks, Day-0 (post deployment validations), Day-1 (post configuration), Day-2 (integration and connectivity checks to adjacent systems), and the like.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

Thus, in some examples, the method 200 simplifies the process of identifying relevant test cases for execution against a mobility network and maximizes the probability of executing the correct test suite against the mobility network. Examples of the method 200 may also speed the process of testing releases with new features by allowing a regression to be run on available features that have already been automated, ensuring the stability of the latest releases and marking existing functionalities as intact. Examples of the method 200 require no modifications to automation pipelines that are executed or shared within systems to perform test executions; instead, only the tags within the text automation can be modified. This reduces the resources required to coordinate between systems, and also allows for rapid changes in test scope without extension reconfiguration of dependent systems.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for executing mobility tests through tags called via application programming interfaces, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for executing mobility tests through tags called via application programming interfaces (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for executing mobility tests through tags called via application programming interfaces (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor, an identification of a first tag indicating a testing criterion for a test to be executed against a mobility network;
identifying, by the processing system from among a plurality of test cases, a subset of the plurality of test cases to which the first tag has been applied;
generating, by the processing system, a test suite including the subset of the plurality of test cases;
executing, by the processing system, the test suite against an element of the mobility network; and
exposing, by the processing system, a result of the executing the test suite via an application programming interface.

2. The method of claim 1, wherein the first tag describes a third generation partnership project-specific scenario.

3. The method of claim 2, wherein the third generation partnership project-specific scenario is at least one of: a scenario for attach, a scenario for voice over long term evolution, or a scenario for voice over new radio.

4. The method of claim 1, wherein the first tag describes a test category.

5. The method of claim 4, wherein the test category is at least one of: an integration category, a regression category, a development category, a nodal category, or a chaos category.

6. The method of claim 1, wherein the first tag describes a release number or a version of a feature of the mobility network.

7. The method of claim 1, wherein the first tag describes a zone name of a zone of the mobility network.

8. The method of claim 1, wherein the first tag is one of a plurality of tags indicating testing criteria for the test.

9. The method of claim 8, wherein the identifying is repeated for each tag of the plurality of tags, and at least one further test case identified as a result of the repeating is included in the test suite.

10. The method of claim 1, wherein the generating the test suite comprises queuing the subset of the plurality of test cases in an order for execution.

11. The method of claim 10, wherein the order for execution is determined at least in part based on resource availability.

12. The method of claim 1, wherein the element of the mobility network is a network function.

13. The method of claim 1, further comprising:
determining, by the processing system, that the first tag has been removed from a first test case of the subset of the plurality of test cases; and
removing, by the processing system, the first test case from the test suite prior to the executing.

14. The method of claim 13, wherein the removing changes a scope of the test suite without making a change to an application programming interface used to execute the test suite.

15. The method of claim 1, further comprising adding, to the test suite, a second test case to which the first tag was applied after the identifying.

16. The method of claim 1, wherein at least one test case of the plurality of test cases has been previously executed against a system.

17. The method of claim 1, wherein the first tag is selected by a user via a graphical user interface.

18. The method of claim 1, wherein the first tag is automatically called by a system external to the processing system.

19. A non-transitory computer-readable medium storing instructions which, when executed by a processing system including at least one processor, cause the processing system to perform operations, the operations comprising:
receiving an identification of a first tag indicating a testing criterion for a test to be executed against a mobility network;
identifying, from among a plurality of test cases, a subset of the plurality of test cases to which the first tag has been applied;
generating a test suite including the subset of the plurality of test cases;
executing the test suite against an element of the mobility network; and
exposing a result of the executing the test suite via an application programming interface.

20. A device comprising:
a processing system including at least one processor; and
a non-transitory computer-readable medium storing instructions which, when executed by the processing system, cause the processing system to perform operations, the operations comprising:
receiving an identification of a first tag indicating a testing criterion for a test to be executed against a mobility network;
identifying, from among a plurality of test cases, a subset of the plurality of test cases to which the first tag has been applied;
generating a test suite including the subset of the plurality of test cases;
executing the test suite against an element of the mobility network; and
exposing a result of the executing the test suite via an application programming interface.
